(19) United States
(12) Patent Application Publication
(10) Pub. No.: US 2020/0281158 A1
(43) Pub. Date: Sep. 10, 2020

(54) Pet Bed Covering Assembly

(71) Applicant: Lucille Harbo, Ponce De Leon, FL (US)

(72) Inventor: Lucille Harbo, Ponce De Leon, FL (US)

(21) Appl. No.: 16/296,822

(22) Filed: Mar. 8, 2019

(51) Int. Cl. A01K 1/035

(52) U.S. Cl. CPC A01K 1/0353

(57) ABSTRACT

A pet bed covering assembly for inhibiting a pet bed from becoming soiled includes a covering that is positionable over and around a pet bed. In this way the covering inhibits a pet from physically contacting the pet bed when the pet lies in the pet bed. The covering is infused with a chemical scent to conceal unpleasant odors associated with the pet. The covering is infused with a chemical insect repellant to repel fleas and other insect parasites. An elastic band is coupled to covering and the elastic band tightens the covering around the pet bed for removably retaining the covering on the pet bed.

### (b) CROSS-REFERENCE TO RELATED APPLICATIONS

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to covering devices and more particularly pertains to a new covering device for inhibiting a pet bed from becoming soiled.

### (h) BRIEF SUMMARY OF THE INVENTION

An embodiment of the disclosure meets the needs presented above by generally comprising a covering that is positionable over and around a pet bed. In this way the covering inhibits a pet from physically contacting the pet bed when the pet lies in the pet bed. The covering is infused with a chemical scent to conceal unpleasant odors associated with the pet. The covering is infused with a chemical insect repellant to repel fleas and other insect parasites. An elastic band is coupled to covering and the elastic band tightens the covering around the pet bed for removably retaining the covering on the pet bed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a pet bed covering assembly according to an embodiment of the disclosure.

FIG. 2 is a bottom view of an embodiment of the disclosure.

FIG. 3 is a perspective in-use view of an embodiment of the disclosure showing a pet bed being inserted into an opening in a covering.

FIG. 4 is a perspective in-use view of an embodiment of the disclosure showing a covering being positioned around a pet bed.

FIG. 5 is a perspective exploded view of an embodiment of the disclosure.

### (j) DETAILED DESCRIPTION OF THE INVENTION

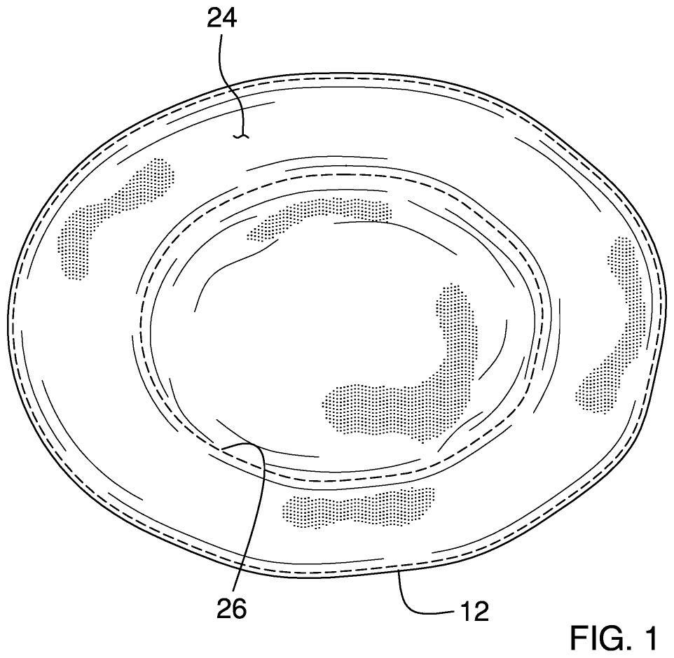

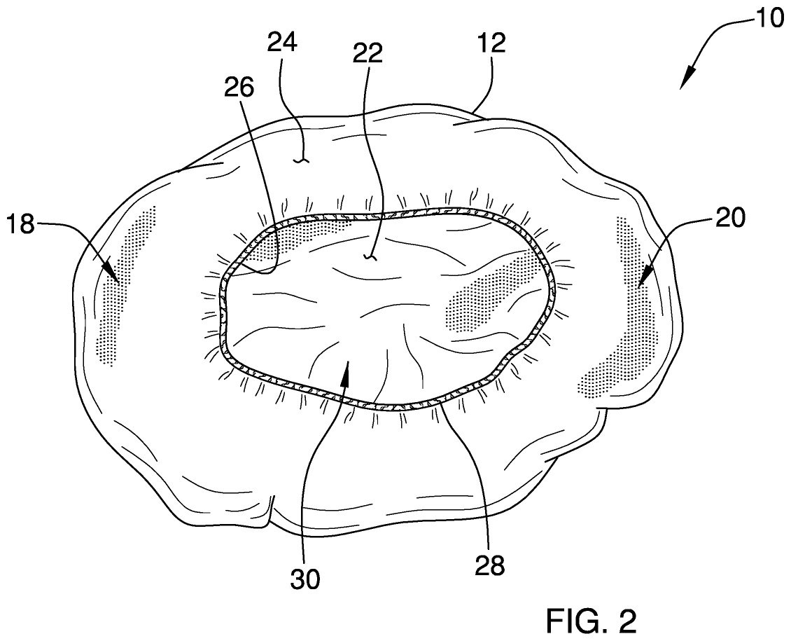

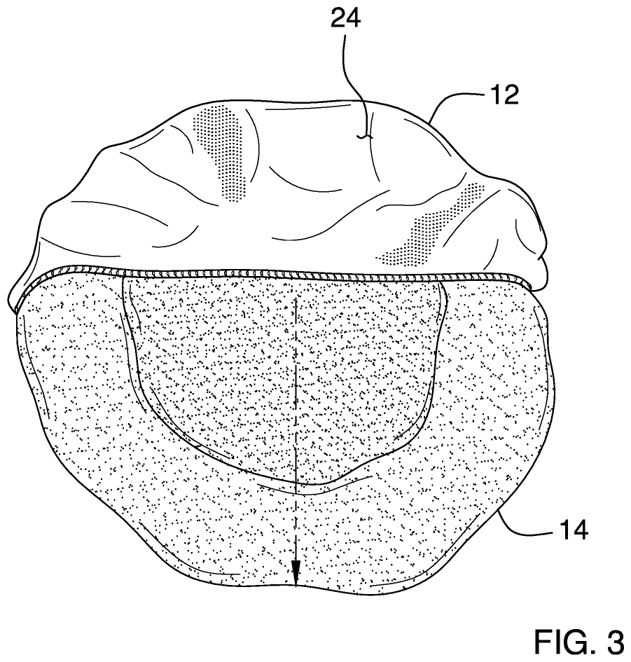

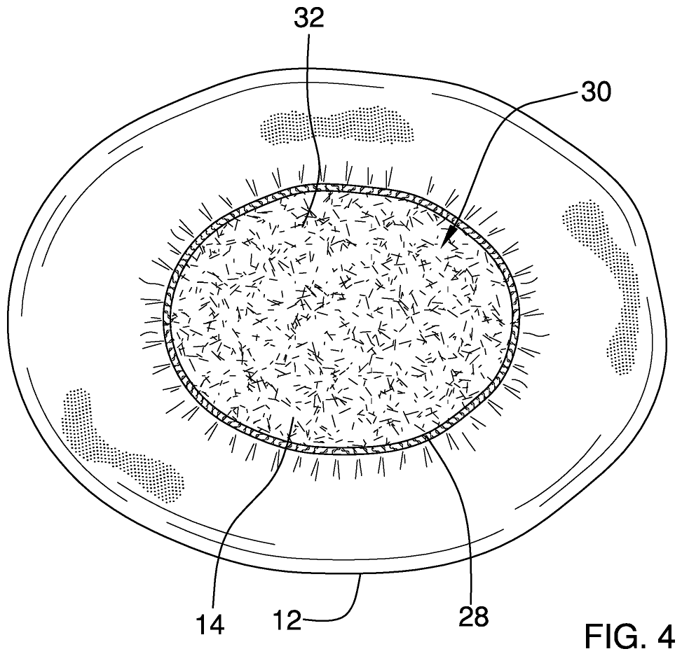

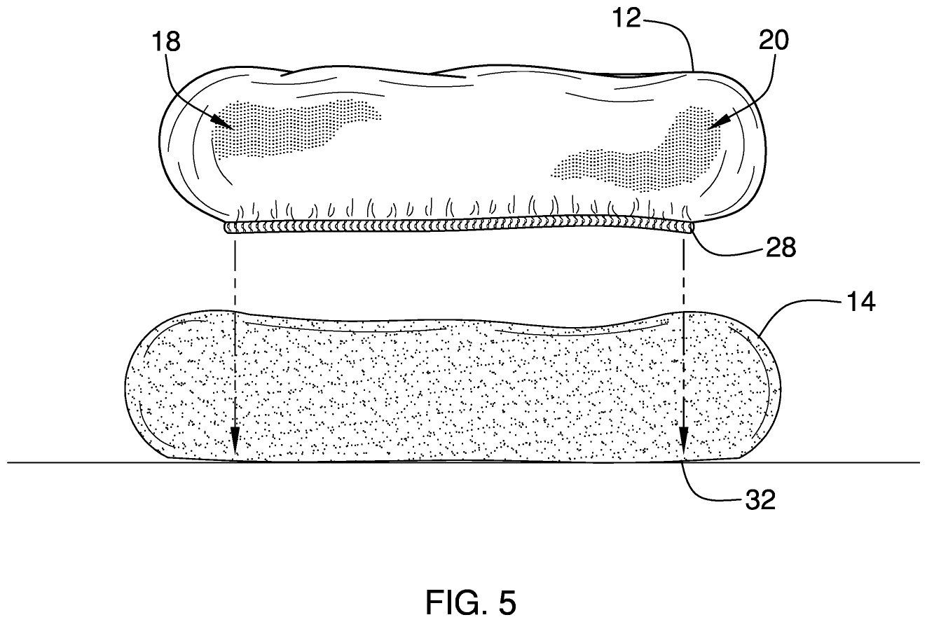

With reference now to the drawings, and in particular to FIGS. 1 through 5 thereof, a new covering device embodying the principles and concepts of an embodiment of the disclosure and generally designated by the reference numeral 10 will be described.

As best illustrated in FIGS. 1 through 5, the pet bed covering assembly 10 generally comprises a covering 12 that is positionable over and around a pet bed 14. In this way the covering 12 inhibits a pet from physically contacting the pet bed 14 when the pet lies in the pet bed 14. The covering 12 is infused with a chemical scent 18 to conceal unpleasant odors associated with the pet. The chemical scent 18 may be a floral scent, such as lavender, or other pleasing scent. Additionally, the covering 12 is infused with a chemical insect repellant 20 to repel fleas and other insect parasites. The covering 12 has first surface 22, a second surface 24 and a peripheral edge 26 extending therebetween. The peripheral edge 26 is continuously arcuate such that the covering 12 has a rounded shape. Moreover, the first surface 22 rests on the pet bed 14 when the covering 12 is positioned on the pet bed 14 such that the pet lies on the second. The pet may be a dog, a cat or any other domesticated mammal.

An elastic band 28 is coupled to covering 12 and the elastic band 28 tightens the covering 12 around the pet bed 14 for removably retaining the covering 12 on the pet bed 14. The elastic band 28 is coextensive with the peripheral edge 26 of the covering 12 such that the elastic band 28 draws peripheral edge 26 over the first surface 22 of the covering 12. In this way an opening 30 is defined in the covering 12. The opening 30 is positioned around the pet bed 14 having the elastic band 28 being positioned on a bottom side 32 of the pet bed 14. The elastic band 28 draws the peripheral edge 26 along the bottom side 32 of the pet bed 14 for covering 12 the pet bed 14.

In use, the covering 12 is positioned over and around the pet bed 14 such that the pet lies on the covering 12 when the pet lies on the pet bed 14. The chemical scent 18 enhances the overall odor of the pet bed 14 and the chemical insect repellant 20 repels fleas and other insect parasites. In this way the covering 12 enhances the comfort of the pet while the pet lies on the pet bed 14. The covering 12 is removed from the pet bed 14 once the covering 12 becomes visibly soiled from the pet and the covering 12 is subsequently disposed of. A new covering 12 is then placed over and around the pet bed 14. In this way the service life of the pet bed 14 is enhanced as well as enhancing the comfort of the pet.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pet bed covering assembly being configured to cover a pet bed and be subsequently disposed of thereby protecting the pet bed from becoming soiled, said assembly comprising:
a covering being positionable over and around a pet bed wherein said covering is configured to inhibit a pet from physically contacting the pet bed when the pet lies in the pet bed, said covering being infused with a chemical scent wherein said covering is configured to conceal unpleasant odors associated with the pet, said covering being infused with a chemical insect repellant wherein said covering is configured to repel fleas and other insect parasites; and
an elastic band being coupled to covering, said elastic band tightening said covering around the pet bed for removably retaining said covering on the pet bed.

2. The assembly according to claim 1, wherein said covering has a first surface, a second surface and a peripheral edge extending therebetween, said peripheral edge being continuously arcuate such that said covering has a rounded shape, said first surface resting on the pet bed when said covering is positioned on said pet bed wherein said second surface is configured to have the pet lie thereon.

3. The assembly according to claim 1, wherein:
said covering has a peripheral edge and a first surface;
said elastic band is coextensive with said peripheral edge of said covering such that said elastic band draws said peripheral edge over said first surface of said covering to define an opening into said covering.

4. The assembly according to claim 3, wherein said opening is positioned around the pet bed having said elastic band being positioned on a bottom side of the pet bed thereby facilitating said elastic band to draw said peripheral edge along the bottom side of the pet bed for covering the pet bed.

5. A pet bed covering assembly being configured to cover a pet bed and be subsequently disposed of thereby protecting the pet bed from becoming soiled, said assembly comprising:
a covering being positionable over and around a pet bed wherein said covering is configured to inhibit a pet from physically contacting the pet bed when the pet lies in the pet bed, said covering being infused with a chemical scent wherein said covering is configured to conceal unpleasant odors associated with the pet, said covering being infused with a chemical insect repellant wherein said covering is configured to repel fleas and other insect parasites, said covering having first surface, a second surface and a peripheral edge extending therebetween, said peripheral edge being continuously arcuate such that said covering has a rounded shape, said first surface resting on the pet bed when said covering is positioned on said pet bed wherein said second surface is configured to have the pet lie thereon; and
an elastic band being coupled to covering, said elastic band tightening said covering around the pet bed for removably retaining said covering on the pet bed, said elastic band being coextensive with said peripheral edge of said covering such that said elastic band draws said peripheral edge over said first surface of said covering to define an opening into said covering, said opening being positioned around the pet bed having said elastic band being positioned on a bottom side of the pet bed thereby facilitating said elastic band to draw said peripheral edge along the bottom side of the pet bed for covering the pet bed.

6. A method of protecting a pet bed from becoming soiled, said method comprising the steps of:
providing a pet bed having a bottom side;
providing a covering, said covering being infused with a chemical scent wherein said covering is configured to conceal unpleasant odors associated with the pet, said covering, said covering being infused with a chemical insect repellant wherein said covering is configured to repel fleas and other insect parasites, said covering having first surface, a second surface and a peripheral edge extending therebetween, said peripheral edge being continuously arcuate such that said covering has a rounded shape, said first surface resting on the pet bed when said covering is positioned on said pet bed wherein said second surface is configured to have the pet lie thereon;
providing an elastic band, said elastic band being coupled to covering, said elastic band tightening said covering around the pet bed for removably retaining said covering on the pet bed, said elastic band being coextensive with said peripheral edge of said covering such that said elastic band draws peripheral edge over said first surface of said covering to define an opening in to said covering, said opening being positioned around the pet bed having said elastic band being positioned on a bottom side of the pet bed thereby facilitating said elastic band to draw said peripheral edge along the bottom side of the pet bed for covering the pet bed; and
placing said covering over the pet bed such that said elastic band tightens said peripheral edge of said covering onto the bottom side of the pet bed.
